(19) United States
(12) Patent Application Publication
(10) Pub. No.: US 2007/0240134 A1
(43) Pub. Date: Oct. 11, 2007

(54) Software packaging model supporting multiple entity types

(76) Inventors: Joydeep Buragohain, Aloha, OR (US); Michael A. Jastad, Portland, OR (US); Muthu A. Muthiah, Beaverton, OR (US); Sudhir G. Rao, Portland, OR (US)

Correspondence Address: LIEBERMAN & BRANDSDORFER, LLC, 802 STILL CREEK LANE, GAITHERSBURG, MD, 20878, US

(21) Appl. No.: 11/364,311

(22) Filed: Feb. 28, 2006

(51) Int. Cl. G06F 9/45

(52) U.S. Cl. 717/140

(57) ABSTRACT

A hierarchical packaging model of self-describing plugin modules and packages of plugin modules. Identifiers are assigned to each package of plugin modules in a hierarchical relationship so that adjacently identified packages are backward compatible. The package identifiers are maintained internally to the package. Similarly, identifying data of a plugin module is maintained internally within the namespace of the respective module. Interdependency of plugin modules is determined by comparison of data maintained in the namespace of each module.

### BACKGROUND OF THE INVENTION

1. Technical Field

This invention relates to the field of computer systems. More specifically, the invention relates to computer software plugin modules and installation thereof.

2. Description of the Prior Art

In computer network application, it is common for an application running at a particular computer to interact with or use another application that may be located at the same computer or at a different computer in communication therewith via a network connection. Technology in the computer area is subject to change on an ongoing basis, both in the hardware and software technologies. As a result, computer applications in a network environment are often faced with changes in the network environment, whether they are changes in software application used by a program or changes in hardware, such as changing the machines or connections used to run services in the network environment. The challenge of adapting to new technologies resides not only with the end user or client side, but also with the network service provider.

A base module is basic software and/or hardware that enables client machines and servers to operate. A plugin module extends the functionality of the base module with value added services, wherein the value added services may be standard compliant services or proprietary services. The plugin is the smallest identifiable compiled code used to implement a feature or a set of features. In one embodiment, the plugin module may provide additional services needed for a new device type that is not supported by the base module. Computer software products that require modification or extension after the base module software products are up and running on a client machine are typically extended using a plugin module that interfaces the client system where the software product resides. The client machines must recognize and install the appropriate plugin to complete a software extension and must interface both the plugin module and the software product. The responsibility for all knowledge of how to verify the appropriateness of the use of a specific plugin module resides both in the host computer system as well as all related modules that expect to use the plugin.

The base of information grows exponentially as plugin modules are added and evolve over the life cycle of the software product. Upgrades to existing modules may be required each time a new individual plugin is defined. For example, in a conventional client-server system, management of distributed state information for the system requires storage of per-client state information at the service end so that services can rely on certain facts about the client state. Similarly, a server stores overhead information about the particular program(s) and version(s) available at a client to permit proper interaction between the server and client. In one embodiment, extensions are used to maintain compatibility information as plugin modules expand. Each new software extension or plugin module creates a new set of module interdependencies that must be maintained in all modules that expect to use the newly created plugin. The controlling system must contain all information about the management of the plugin prior to actually loading it and providing its services to the software system. User intervention is typically required to effectuate the plugin module.

A server and storage management architecture directly leads to a need to support multiple server types, device types, fabric-types, services, etc., wherein fabric is another term for storage area networks. As a management application associated with the architecture evolves, there is a need to add support for additional devices, fabric types, and services that may have been added to the architecture. Added services may have dependencies on base services. New services may need to be backward compatible with one or more dependent service versions. In addition, the architecture needs to support an application packaging and deployment model for revenue generation as the customer's needs grow, while reducing customer difficulties experienced during deployment.

One prior art solution is shown in U.S. Pat. No. 6,871,345 issued to Crow et al. This patent describes a plugin manager that uses plugins with some introspection capability to determine what resources they need. The plugin manager allows for plugin deployment. However, there is no teaching or support of packaging plugin modules to classify services in a hierarchical manner.

Therefore, there is a need to provide an internal identifier to a plugin module and a package of plugin modules. The package identifiers should be assigned in a hierarchical manner to support compatibility determination between specified packages.

### SUMMARY OF THE INVENTION

This invention comprises a method and system for managing installation of plugin packages and associated plugin modules.

In one aspect of the invention, a method is provided for packaging software. A first identifier is assigned to a first package of one or more plugin modules, including an installed plugin module with an internal namespace. The first identifier is associated with identifying data in the internal namespace. In addition, one or more non-installed plugin modules are compiled into a second package of plugin modules. A second identifier is assigned to the second package of plugin modules. The second identifier is assigned in a hierarchical relationship to the first package identifier and it is associated with identifying data in the internal namespace of the non-installed plugin module. Thereafter, the second identifier of the second package of plugin modules is compared with the first identifier of the first package of plugin modules to determine compatibility of the second package with the first package.

In another aspect of the invention, a computer system is provided with a first package having at least one plugin module and an associated first identifier. The installed plugin module has an internal namespace. This first identifier is associated with identifying data in the internal namespace of the installed module. In addition, a second package is provided having at least one non-installed plugin modules. The second package is assigned an identifier in a hierarchical manner with respect to the first package. In addition, the second package identifier is associated with identifying data in an internal namespace of a non-installed package. A manager is provided in the system to compare the second identifier with the first identifier to determine compatibility of the packages of plugin modules.

In another aspect of the invention, an article is provided with a computer readable medium. Instructions in the medium are provided for assigning a first identifier to a first package of one or more plugin modules, which includes an installed plugin module having an internal namespace. The first identifier is associated with identifying data in the internal namespace. Instructions in the medium are also provided for compiling one or more non-installed plugin modules into a second package of plugin modules. A second identifier is assigned to the second package of plugin modules through instructions in the medium. The second identifier is assigned in a hierarchical relationship to the first package identifier and is associated with identifying data in an internal namespace of a non-installed plugin module. Instructions in the medium are provided for comparing the second identifier of the second package of plugin modules with the first identifier of the first package of plugin modules, and for determining compatibility of the second package of plugin modules with the first package of plugin modules through the comparison of the identifiers.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of a sample package of plugin modules.

FIG. 2 is a block diagram illustrating two sample packages of plugin modules.

FIG. 3 is a block diagram illustrating three sample packages of plugin modules, with each package having multiple plugin modules and each package having different version identifying numbers.

FIG. 4 is a flow chart illustrating installation of a package of plugin modules according to the preferred embodiment of this invention, and is suggested for printing on the first page of the issued patent.

FIG. 5 is a block diagram of illustrating the manager in a client-server environment.

### DESCRIPTION OF THE PREFERRED EMBODIMENT

### Overview

Plugin modules and packages of plugin modules are each assigned unique identifying data based upon characteristics associated therewith. A namespace is created in each plugin module to house the identifying data. During installation of a plugin module, compatibility of the plugin module designated for installation with previously installed plugin modules is determined based upon the identifying data stored in the namespace of both the installed plugin module and the previously installed plugin modules. The compatibility of the plugin modules is based exclusively upon an internal comparison. Accordingly, compatibility of the plugin modules eliminates the requirement to utilize external data or resource(s) during or prior to the installation process.

### Technical Details

The smallest software unit, i.e. compiled code, in this scheme may be in the form of a base module or a plugin module. In one embodiment, the base module or plugin module may be in the form of a shared library or a Java jar file. The base module supports the basic services required for basic configuration of a storage device, fabric, or server. For example, in the context of a storage device, one base module may support one or more disk types, and a second base module may support servers, tapes, and fabric types. A plugin module is different than a base module in that it provides additional features needed for a new device type that is not supported by the base module. Each plugin module is self describing and may include one or more of the following attributes: a name of the plugin, a version identifier associated with the plugin, the capabilities of the plugin, a list of dependencies, and a checksum. The attributes of the plugin may be compiled into code and be always in memory. In one embodiment, the memory that stores the plugin attributes is volatile memory. The name of the plugin is used for development, test, and field support, and is not visible to the customer. In one embodiment, the name may be in the form of a string. Similarly, the version identifier is used for development, test, and field support, and is not visible to the customer. In one embodiment, the version identifier is an integer. The capability vector may be a compilation of data indicating the device the plugin can support. In one embodiment, the capability vector may be a compilation of bits. The dependency list may be a compilation of data that communicates compatibility of the base or plugin module with other modules or packages of modules. In one embodiment, the dependency list may be in the form of a compatibility vector. Capture of the dependencies presents a method for resolving dependency issues among both base modules and plugin modules, and enabling customers to purchase missing plugins in packages. The checksum of bytecode of a plugin is a security feature to ensure that properties of the plugin have not been corrupted. The properties described herein, i.e. name, version, capability vector, dependency list, and checksum, should not be considered limiting. This list of properties may be reduced or expanded as needed. Each plugin is self describing based upon its properties, including the above described properties.

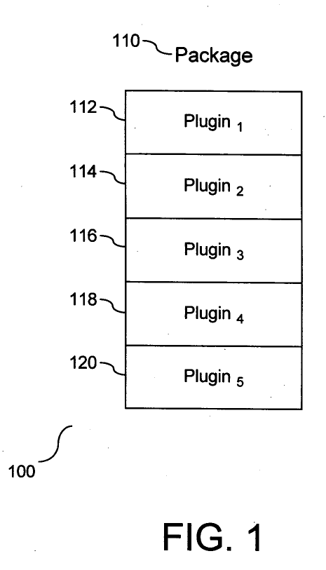

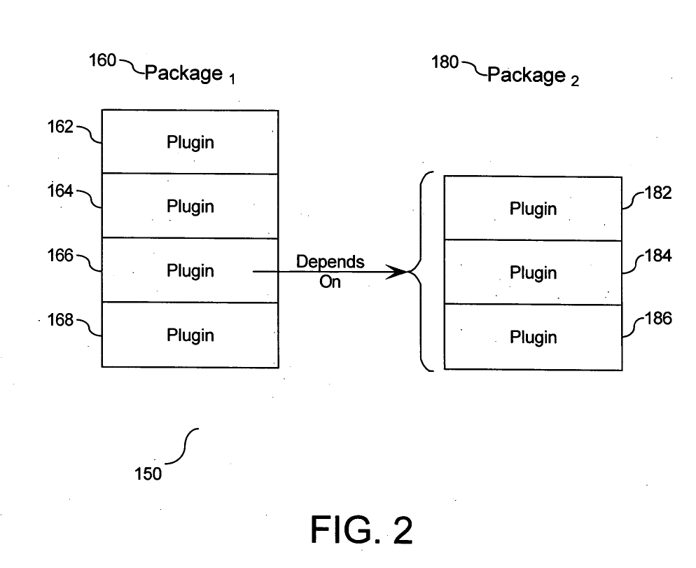

The next hierarchical larger software unit from a plugin is a package comprising zero or one base modules and at least one plugin modules. In one embodiment, a package may be an aggregation of plugin libraries or Java jar files. A package is an installable entity on a server or client machine. Each package may be defined to be compatible and assigned to function with a specific storage device, server, or fabric type. Each plugin module in a package is compatible with other plugin modules in the same package. In one embodiment, one or more plugins of a package may have dependencies on other plugin modules that reside in another package. FIG. 1 is a block diagram (100) illustrating a sample package of plugin modules (110). As shown, the package (110) includes a plurality of plugin modules (112), (114), (116), . . . (120). The quantity of plugin modules shown herein is for illustrative purposes, and the package may include more or less plugins than those shown herein. FIG. 2 is a block diagram (150) illustrating two sample packages of plugin modules, package₁ (160) and package₂ (180). The first plugin package (160) includes four plugin modules (162), (164), (166), and (168). The second plugin package (180) includes three plugin modules (182), (184), and (186). The third plugin module (166) of the first package (160) is shown to be dependent on the three plugin modules (182), (184), and (186) of the second package (180).

Each package of plugin modules includes a version identifier. In one embodiment, a package version identifier is generated at the time of release of the package of plugin modules. The package identifier may be generated using an identifier from each plugin module that comprise the package of plugin modules. In one embodiment, the package version string is generated by packaging scripts or a java program prior to a management application release of the package. The package version identifier is incremented each time a plugin module version in the package changes to provide a hierarchical packaging model. Regardless of the version of the plugin in a package, plugin modules in a package with a defined version are tested for backward compatibility with plugin modules in a package with an assigned prior version identifier based upon the defined hierarchy. For example, plugin modules in a package with version_{N+1} are tested for compatibility with plugin modules in a prior package with version_{N}. Each version of a package bears a correlation with the most recently changed plugin module or an added plugin module in a hierarchy of packages of plugin modules to ensure backward compatibility. Furthermore, each package may support one or more services. A service or services can be deployed by determining which package, i.e. grouping of plugin modules, supports the desired service. Accordingly, each package of plugin modules will guarantee support of an adjacent previous version, but will not guarantee support of other earlier versions.

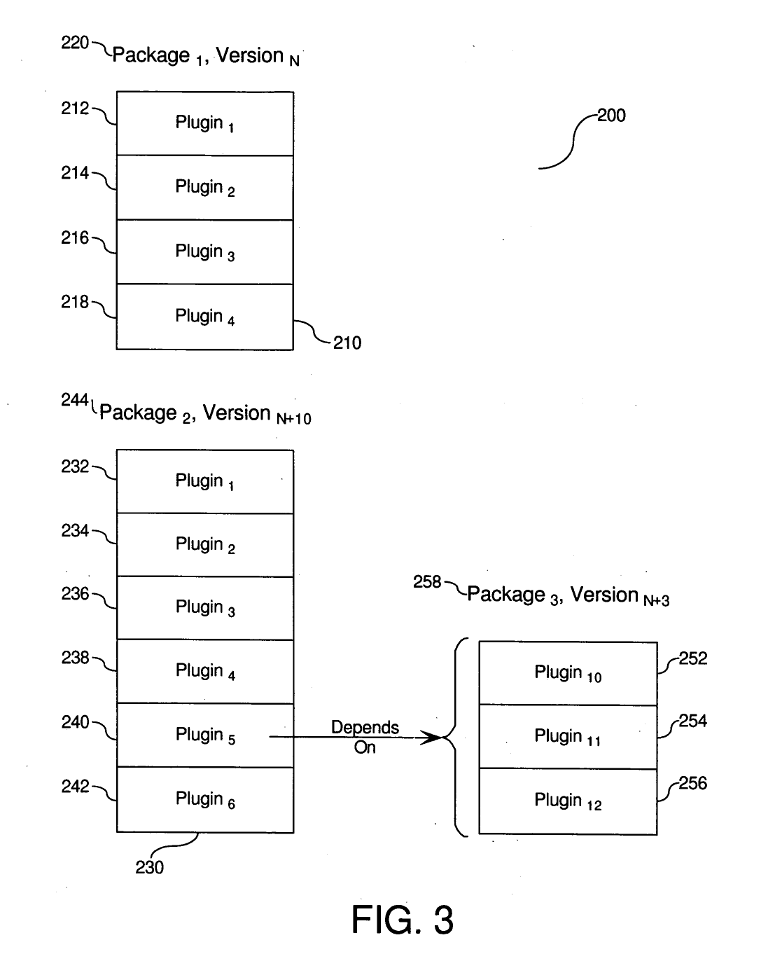

FIG. 3 is a block diagram (200) showing three packages of plugins, with each package having multiple plugin modules and each package having different version identifying numbers. The first package, package₁, (210), has four plugins, plugin₁ (212), plugin₂ (214), plugin₃ (216), and plugin₄ (218). In addition, the first package (210) has a version identifier, N, (220). The second package, package₂, (230), is an upgrade of the first package, package₁ (210) with two additional plugins. The second package, package₂, (230) has a total of six plugins, plugin₁ (232), plugin₂ (234), plugin₃ (236), plugin₄ (238), plugin₅ (240), and plugin₆ (242), and a version identifier (N+10), (244). Plugin₅ (240) and plugin₆ (242) are additions to package₁ (210), and plugin₁ (212), plugin₂ (214), plugin₃ (216), and plugin₄ (218) of package₁, version_{N} are identical to plugin₁ (232), plugin₂ (234), plugin₃ (236), and plugin₄ (238) of package₂ version_{N+10}. As shown, plugin₅ (240) of the second package (230) is dependent on three other plugins that are a part of a third package of plugins, package₃ (250). The third package, package₃ (250), has a total of three plugins, plugin₁₀ (252), plugin₁₁ (254), and plugin₁₂ (256). In addition, the third package (250) has a version identifier (N+3) (258). Accordingly, as shown there are three packages of plugin which include interdependency of plugins between the packages.

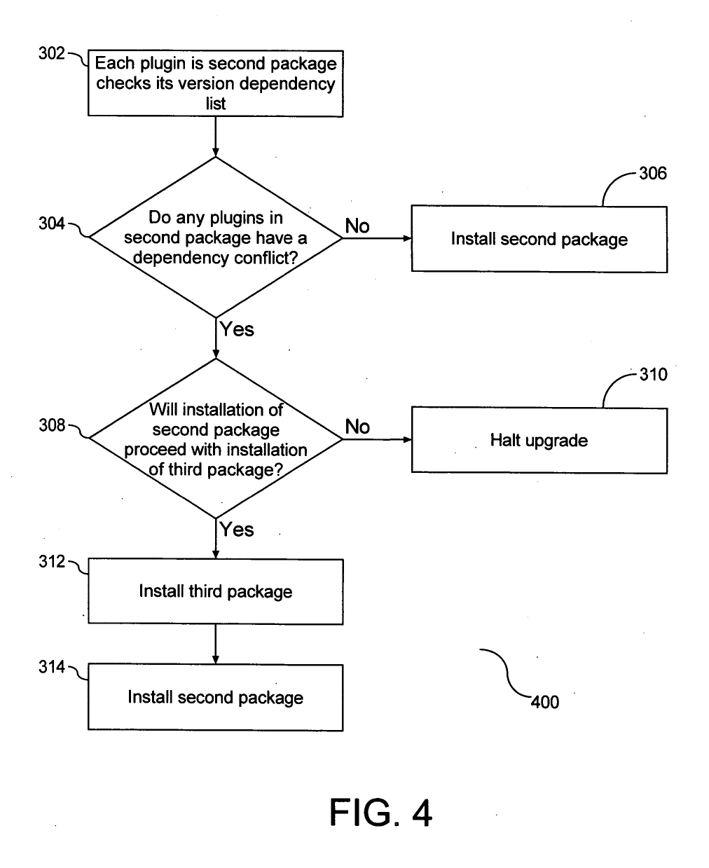

At the time of release of the management application, a package identity plugin is created returning a map comprised of the package, the name of the device, server, and/or fabric type, and the name of the plugin. In one embodiment the package identity plugin may be generated by packaging scripts or a java application. This map is generated using the plugin identity class for each plugin in the package. This class also captures the package version string that is generated prior to the management application release. In one embodiment, the package version string is generated by packaging scripts or a java program. This packaging technique encapsulates the server, device and/or fabric type and service information in the namespace of the plugin module(s) and plugin package(s). As such, the plugin module(s) and associated package(s) are self describing. The version information for the plugins and associated packages are maintained internally. There is no need to consult a resource external to the plugin and/or associated plugin package during an upgrade installation, since all of the required data is maintained internally with the plugin and/or associated plugin package. 15 FIG. 4 is a flow chart (400) illustrating an example of a process for installing a package of plugins that is an upgrade to a previously installed package as shown in FIG. 3 using the self describing information retained with each plugin. A customer has a first package, package,, that has a property version, version_{N}. As shown in FIG. 3, the first package includes several plugins and an associated version identifier. The customer wants to upgrade the first package at version_{N}, to the second package at version_{N+10}. Four of the plugins present in the second package are identical to the plugins in package₁, version_{N}. However, one of the plugins in the second package, plugins, which is not present in the first package is dependent upon three plugins, plugin₁₀, plugin₁₁, and plugin₁₂, that are not present in either package₁, version_{N}, or package₂, version_{N+10}. The process for upgrading from the first package of plugins to the second package of plugins is initiated with each plugin in the second package checking its version dependency list (302), which is one of the self describing attributes of the plugin stored in memory. In one embodiment, the dependency list is maintained in the namespace. After the discovery process at step (302), it is determined if any of the plugins in the second package have discovered a dependency conflict (304). In one embodiment, a dependency conflict may be in the form of a dependency of one of the upgrade plugins to another plugin that is not present in an installed package or a package that is in the process of being installed. For example, as shown in FIG. 3, plugin₁₁ is a part of a third package of plugins, i.e. package₃, version_{N+3}. A negative response in step (304) will result in installation of the second package (306). However, a positive response in step (304) will result in a subsequent determination whether the installation of the second package will proceed together with the installation of the third package (308). In this example, a negative response in step (308) will halt the upgrade process (310). However, a positive response in step (308) will result in installing the third package of plugins, i.e. package₃, version_{N+3}, prior to installing the second package housing the dependent plugin (312). Following the installation of the third package at step (312), the installation process proceeds with installing the second package, i.e. package₂, version N₊₁₀ (314). The installation is completed, when the installation of the interdependent package, i.e. the second package, is complete. During the installation process outlined in FIG. 4, all of the instructions and logic required to complete the upgrade of packages and associated plugins is contained in the packages designated for installation. All of the information and logic for installation is maintained in package₁, version_{N}, package₂, version_{N+10}, and package₃, version_{N+3}. Accordingly, each plugin in a package consults its own internal resource to determine compatibility during an upgrade of one or more plugin modules or plugin packages.

The invention can take the form of a hardware embodiment, a software embodiment or an embodiment containing both hardware and software elements. In one embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

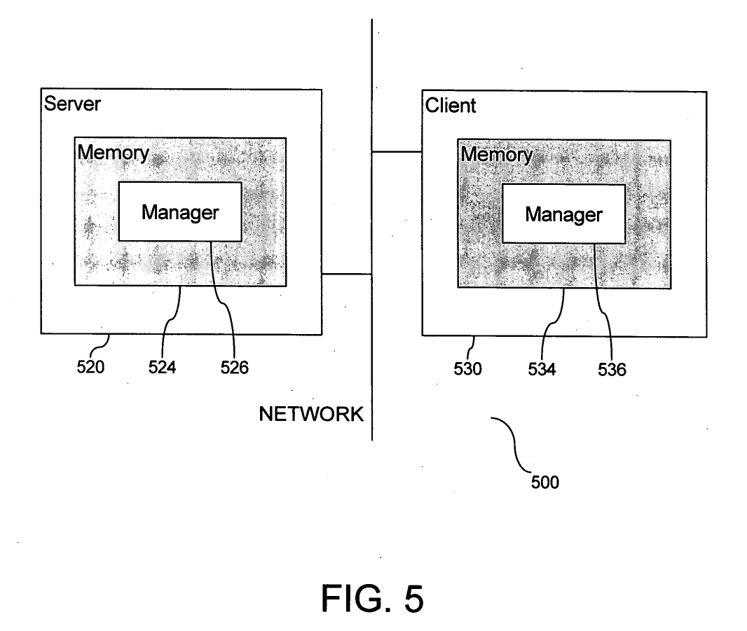

In one embodiment, a manager is provided to facilitate upgrade of packages. FIG. 5 is a block diagram (500) illustrating the manager in a client-server environment in software, which includes but is not limited to firmware, resident software, microcode, etc. The software implementation can take the form of a computer program product accessible from a computer-useable or computer-readable medium providing program code for use by or in connection with a computer or any instruction execution system. The illustration only shows one server (520) and one client machine (530) for illustrative purposes. However, the system may be enlarged to include multiple client machines and servers communicating across a network. As shown, both the server (520) and the client machine (530) each include memory (524) and (534), respectively. The server memory (524) includes a manager (526) embedded therein, and the client memory (534) includes a manager (536) embedded therein. A plugin module or a package of plugin modules may be installed directly on each client machine independent of the server, or in some cases, through instructions received form the server manager. In the case of the client machine (530) receiving upgrade instructions from the server (520), the instructions are communicated through the respective managers (526) and (536). The client manager (536) communicates with the server manager (526) across the network (540) to query the server manager (526) for an identifier associated with the plugin module or package of plugin modules designated to be installed in an upgrade procedure. As noted above, the plugin and package identifiers are self describing identifiers. The manager parses the data provided in the received identifier associated with the plugin or package of plugins to determine compatibility with any previously installed modules or packages of modules, and to facilitate completion of the package upgrade as shown in detail in FIG. 4.

For the purposes of this description, a computer-useable or computer-readable medium can be any apparatus that can contain, store, communicate, propagate, or transport the program for use by or in connection with the instruction execution system, apparatus, or device.

### Advantages Over the Prior Art

Each plugin module and package of modules is a self describing entity that includes a namespace. The information in the namespace of each self describing entity encapsulates the server, device and/or fabric type and service information of the plugin module(s) and plugin package(s). Placement of one or more plugin modules into a package includes assignment of an identifier to the package. The identifier is maintained in the package namespace. During installation of a package of plugin modules, the namespace of the package is consulted to compare the package identifiers to determine compatibility with a previously installed package of plugin modules. The identifiers are assigned in a hierarchical manner and each package of plugin modules is only compatible with an adjacently previous package of plugin modules. Following comparison and approval of the compatibility of the package of plugins, a dependency list in the namespace of the individual plugin modules that are assigned to the package are consulted to determine if any additional package of plugin modules or individual plugin modules are required to support the installation. The data in the namespace eliminates the need to consult an external source for installation to determine compatibility of the current install with an existing base module or previously installed plugin module(s).

### Alternative Embodiments

It will be appreciated that, although specific embodiments of the invention have been described herein for purposes of illustration, various modifications may be made without departing from the spirit and scope of the invention. In particular, property files capturing the information in the plugin identity class and the package identity plugin can be used. Accordingly, the scope of protection of this invention is limited only by the following claims and their equivalents.

We claim:

1. A method for packaging software comprising:
assigning a first identifier to a first package of one or more plugin modules, including an installed plugin module having an internal namespace, wherein said first identifier is associated with identifying data in said internal namespace;
compiling one or more non-installed plugin modules into a second package of plugin modules;
assigning a second identifier to said second package of plugin modules, wherein said second identifier is assigned in a hierarchical relationship to said first package identifier and associated with identifying data in an internal namespace of a non-installed plugin module;
comparing said second identifier of said second package of plugin modules with said first identifier of said first package of plugin modules; and
determining compatibility of said second package of plugin modules with said first package of plugin modules through said comparison of said identifiers.

2. The method of claim 1, further comprising comparing said internal namespace identifying data of said installed plugin module with said internal namespace identifying data of said plugin modules of said second package adapted to be installed.

3. The method of claim 2, wherein said hierarchical assignment of package identifiers supports backward compatibility of adjacently assigned package identifiers.

4. The method of claim 2, wherein said version identifier of said package correlates with a most recently installed plugin module to said package.

5. The method of claim 1, wherein said namespace encapsulates data of the plugin module selected from a group consisting of: a server, a device, fabric type, service information of said plugin module, and combinations thereof.

6. The method of claim 2, further comprising installing a third package of plugins during installation of said second package of plugins when one of said plugin modules of said second package is dependent on a plugin module within said third package of plugins.

7. A computer system, comprising:
an installed plugin module;
a first package of at least one plugin module, including an installed module having an internal namespace, being assigned a first identifier, wherein said first identifier is associated with identifying data in said internal namespace;
a second package of at least one non-installed plugin module assigned a second identifier in a hierarchical manner with respect to said first package and associated with identifying data in an internal namespace of said non-installed package;
a manager adapted to compare said second identifier with said first identifier to determine compatibility of said second package with said first package.

8. The system of claim 7, further comprising said manager comparing said internal namespace identifying data of said installed plugin module with said internal namespace identifying data of said plugin modules of said second package adapted to be installed.

9. The system of claim 8, wherein said hierarchical assignment of package identifiers supports backward compatibility of adjacently assigned package identifiers.

10. The system of claim 8, wherein said version identifier of said package correlates with a most recently installed plugin module to said package.

11. The system of claim 7, wherein said namespace encapsulates data of the plugin module selected from a group consisting of: a server, a device, fabric type, service information of said plugin module, and combinations thereof.

12. The system of claim 8, further comprising a third package of plugin modules adapted to be installed during installation of said second package of plugins when one of said plugin modules of said second package is dependent on a plugin module within said third package of plugin modules.

13. An article comprising:
a computer readable medium;
instructions in said medium for assigning a first identifier to a first package of one or more plugin modules, including an installed plugin module having an internal namespace, wherein said first identifier is associated with identifying data in said internal namespace;
instructions in said medium compiling one or more non-installed plugin modules into a second package of plugin modules;
instructions in said medium for assigning a second identifier to said second package of plugin modules, wherein said second identifier is assigned in a hierarchical relationship to said first package identifier and associated with identifying data in an internal namespace of a non-installed plugin module;
instructions in said medium for comparing said second identifier of said second package of plugin modules with said first identifier of said first package of plugin modules; and
instructions in said medium for determining compatibility of said second package of plugin modules with said first package of plugin modules through said comparison of said identifiers.

14. The article of claim 13, further comprising instructions in the medium for comparing said internal namespace identifying data of said installed plugin module with said internal namespace identifying data of said plugin modules of said second package adapted to be installed.

15. The article of claim 14, wherein said hierarchical assignment of package identifiers supports backward compatibility of adjacently assigned package identifiers.

16. The article of claim 14, wherein said version identifier of said package correlates with a most recently installed plugin module to said package.

17. The article of claim 13, wherein said namespace encapsulates data of the plugin module selected from a group consisting of: a server, a device, fabric type, service information of said plugin module, and combinations thereof.

18. The article of claim 14, further comprising instructions in the medium for installing a third package of plugins during installation of said second package of plugins when one of said plugin modules of said second package is dependent on a plugin module within said third package of plugins.

19. The article of claim 13, wherein the medium is a recordable data storage medium.
